(19) United States
(12) Patent Application Publication
(10) Pub. No.: US 2012/0181340 A1
(43) Pub. Date: Jul. 19, 2012

(54) IDENTIFICATION PLATE HAVING MULTIPLE INFORMATION MEDIA

(76) Inventor: Wei Hsu, New Taipei City (TW)

(21) Appl. No.: 13/157,303

(22) Filed: Jun. 9, 2011

(30) Foreign Application Priority Data
Jan. 14, 2011 (TW) 100200887

(51) Int. Cl. G06K 19/077

(52) U.S. Cl. 235/492

(57) ABSTRACT

An identification plate having multiple information media is a license plate of a motorcycle or car. Statutory words, numbers, and symbols are printed on a surface of the identification plate. A bar code containing the information of the statutory words, numbers, and symbols is arranged to the identification plate. The identification plate has a RF tag containing the same information in the bar code and other relative information such as vehicle registration, inspection record, tax record, periodic inspection record, and payment. A short ranger scanner and a long range reader are used for rapidly acquiring the information contained on the identification plate so as to improve efficiency and reduce lapse of writing. An image identification system can be used to identify the statutory symbols for matching the information of the vehicle and owner.

### FIELD OF THE INVENTION

The present invention relates to RFID, and particular to an identification plate combining a bar code and RF tag for multiple data acquiring and matching.

### DESCRIPTION OF THE PRIOR ART

Management among people, business, and property become more and more complicated through the development of technology. A RFID (Radio Frequency Identification) is used to improve the efficiency of management instead of prior manual methods.

The RFID system includes a Reader, Tag, and application system. Digital information stored in the tag can be accessed by the reader through a wireless transmission method. The data acquired by the reader can be processed by post application system for various purposes.

Present RFID system still has technical and practical problems such as antenna efficiency caused by material, tag detection effected by antenna direction, collision of signal on multiple tags, price of the tag, and communication protocol integration.

However, RFID is still widely applied such as entrance control, medical history system, transportations, toll system, animal tracking, and public transportations of bus, MRT, parking, car renting, and toll system. More and more field could benefit by the RFID system once the previous problems are solved.

Therefore, the present inventor provides an identification plate having multiple information media based on the concept of the RFID so as to benefit the business and the public.

### SUMMARY OF THE PRESENT INVENTION

Accordingly, a primary object of the present invention is to provide an identification plate having multiple information media. The identification plate can be a license plate of a motorcycle or a car. Statutory words, numbers, and symbols are printed on a surface of the identification plate. The identification plate also has a bar code arranged to the identification plate containing the information of the statutory words, numbers, and symbols and a RF tag containing the same information in the bar code and other relative information such as vehicle registration, inspection record, tax record, periodic inspection record, and payment. In parking, the bar code can be scanned by a short range scanner for identification and record so that the efficiency of management will be greatly improved and lapse of writing and be avoided. In additional, the RF tag can be accessed by a long range reader for other information relative to the owner which can be used for post and additional processes. Preferably, a n image identification system can be used to identify the statutory patterns for matching the information of the vehicle and the owner. The present invention can be applied to police investigation or tax check by government administration so as to improve the efficiency. Moreover, storehouse management, library control, entrance control, toll system could use the identification plate of the present invention for better control, record, and tracking

Therefore, the identification plate of the present invention with high practicability can ease the management, save more time, and improve work efficiency.

The various objects and advantages of the present invention will be more readily understood from the following detailed description when read in conjunction with the appended drawing.

### BRIEF DESCRIPTION OF THE DRAWINGS

FIG. 1 is a schematic view showing an identification plate of the present invention.

FIG. 2 is a schematic view showing an operation of the present invention.

FIG. 3 is a schematic view showing an application to parking according to the present invention.

FIG. 4 is a schematic view showing an application to police investigation according to the present invention.

FIG. 5 is a schematic view showing an application to tax administration according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

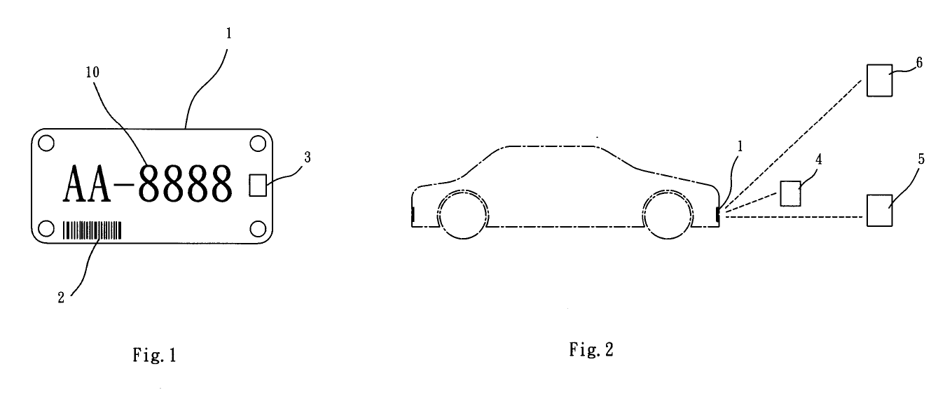

Referring to FIG. 1, a preferable embodiment of an identification plate according to present invention is illustrated. The identification plate 1 can be a license plate of a car or motorcycle. Statutory words, numbers, and symbols are printed on a surface of the identification plate 1. However, the embodiment is not used to confine the scope of the present invention.

The identification plate 1 has the following items besides the statutory words, numbers, and symbols.

A bar code 2 is arranged to the identification plate 1. The bar code 2 contains the information of the statutory words, numbers, and symbols for being scanned by a short range scanner 4 as shown in FIG. 2.

A RF tag 3 (Radio Frequency tag) of high capacity and sensitivity is arranged to the identification plate 1. The RF tag 3 contains the same information in the bar code 2 and other relative information such as vehicle registration, inspection record, tax record, periodic inspection record, and payment. The RF tag 3 can be scanned by a long range reader 5 for information acquiring as shown in FIG. 2. The information stored in the RF tag 3 can be updated anytime.

The information involved in the bar code 2 and RF tag 3 can be modified depending on the needs and is not to confine the scope of the present invention.

The communication between the RF tag 3 and the reader 5 is achieved by radio wave transmission.

Referring to FIG. 2, the bar code 2 and the RF tag 3 are equipped in the front and rear of a vehicle such as a car. The short ranger scanner 4 can scan the bar code 2 for rapidly acquiring the statutory words, numbers, and symbols contained in the bar codes. Relative information can be access by the long range reader 5 from the RF tag 3 in the same time. Preferably, an image identification system 6 can be used to identify the statutory words, numbers, and symbols for matching the information of the vehicle and the owner. The efficiency can be improved and the mistake can be minimized.

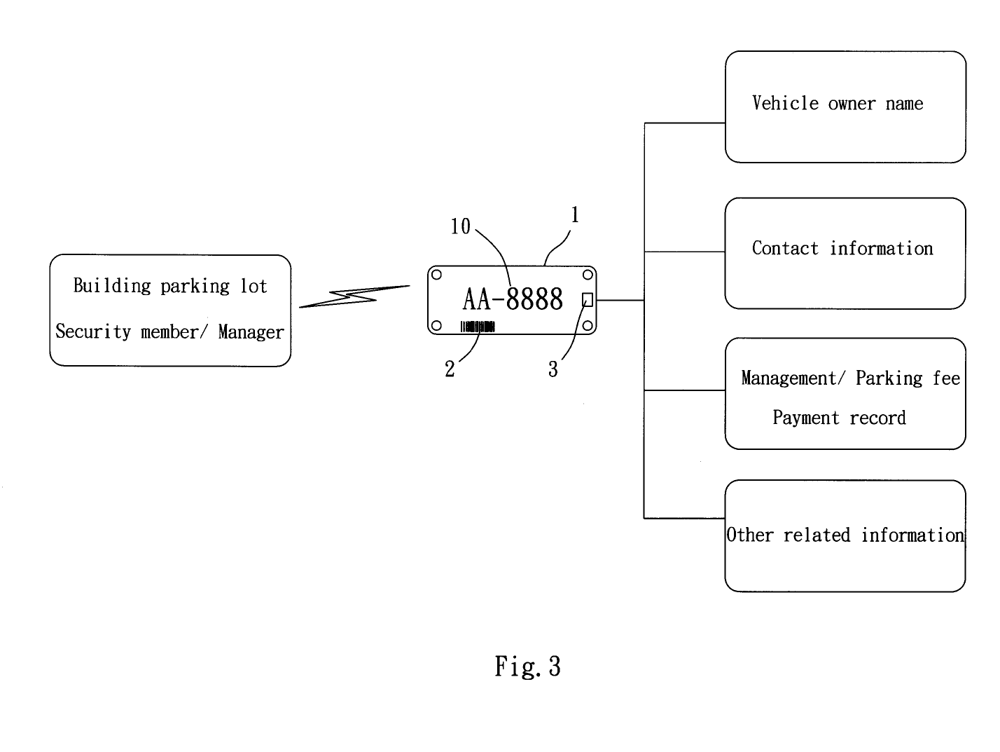

An application of the present invention to parking management is shown in FIG. 3. The bar code 2 of the identification plate 1 can be scanned and recorded in a public parking instead of manual registry. The efficiency of management will be greatly improved and lapse of writing and be avoided. In a private parking, the bar code 2 can be also scanned for entrance management. In additional, the RF tag 3 can be accessed by the long range reader 5 for information relative to owner, vehicle color for remind of parking fee, management fee or for further control against a theft or security issue. Preferably, the image identification system 6 can be used to identify the statutory words, numbers, and symbols for matching the information of the vehicle and the owner.

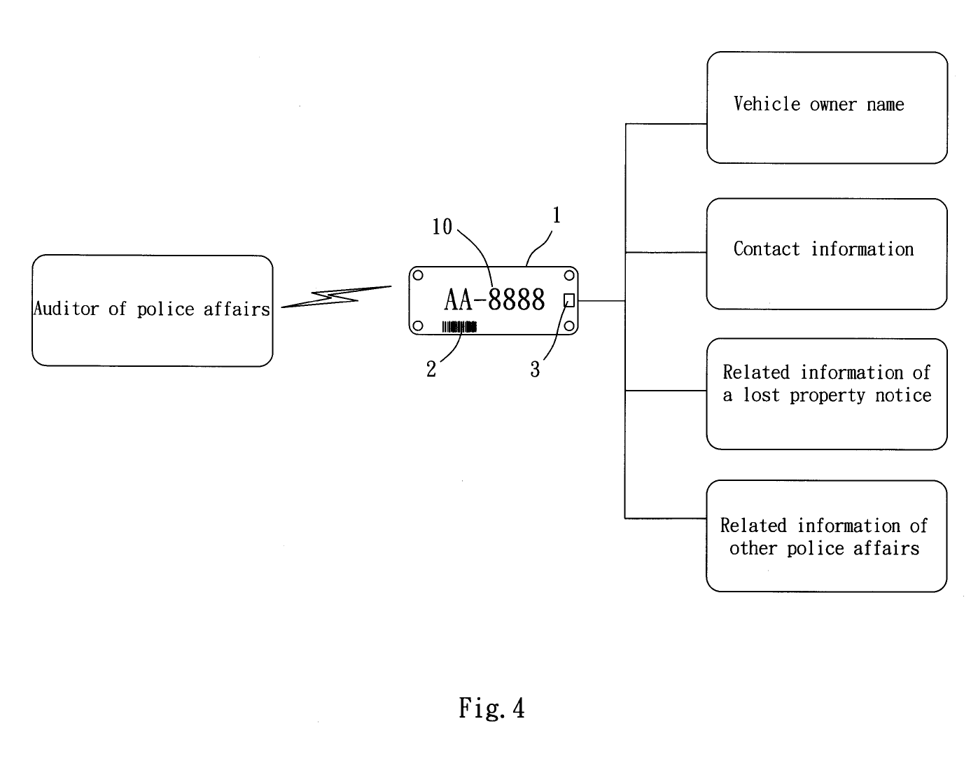

Another application of the present invention to police investigation is shown in FIG. 4. The bar code 2 can be scanned by the short range scanner 4 and the information acquired will be linked to a database for searching for stolen vehicle. During a random inspection, police man could use the short range scanner 4 to scan the bar code 2 or use the long range reader 5 to read the RF tag 3 for information relative to the vehicle and the owner. The information can be linked to a database for vehicle and driver identification. The police don't need to note or inquire to avoid mistake and false information so as to improve the efficiency of investigation.

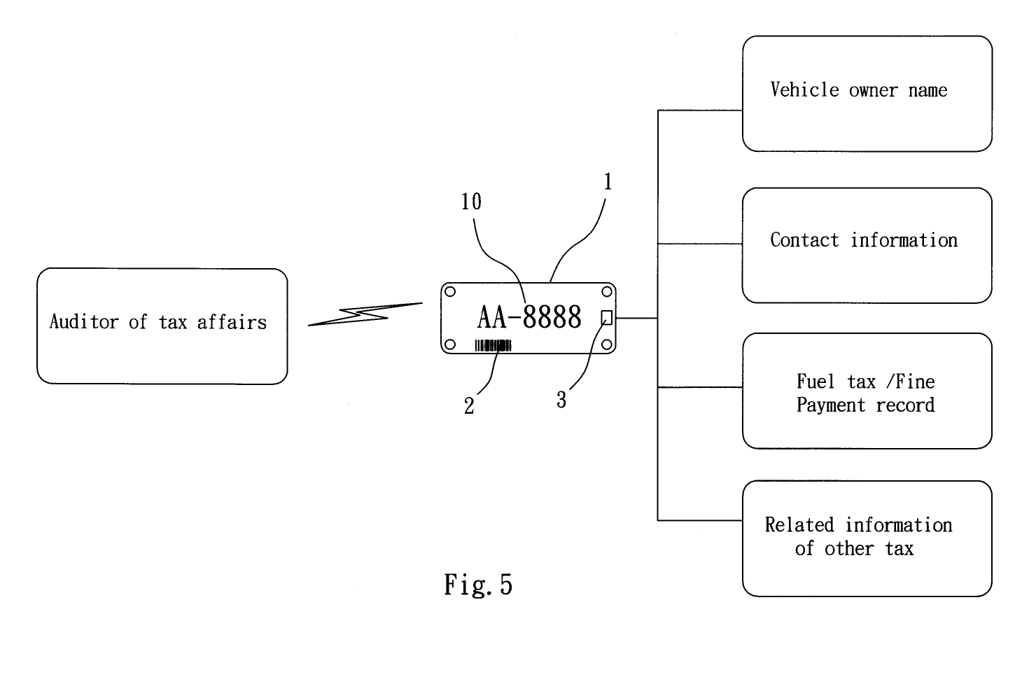

Moreover, a yet application of the present invention to motor vehicle administration is shown in FIG. 5. Tax and ticket relative to the vehicle can be stored in the RF tag 3 for checked by motor vehicle administration. A smog check result and periodic check record can be stored in the RF tag 3. Therefore, above information and record can be easily checked through the short range scanner 4 and long range reader 5 so as to improve quality and efficiency. Tag for inspection qualified is no longer needed to be attached on the license plate which is easily broken, polluted and causing problem of identification and outer appearance.

Therefore, the present invention can be widely applied to parking management, police investigation, or tax check. However, the application is not used to confine the scope of the present invention. A storehouse management, library control, entrance control, toll system could use the identification plate of the present invention for better control, record, and tracking.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An identification plate having multiple information media comprising:
a bar code arranged to the identification plate for being scanned by a scanner; and
a RF tag of high capacity and sensitivity arranged to the identification plate; the RF tag containing the same information as the bar code and other relative information; the RF tag being scanned by a wireless reader for information acquiring; the information stored in the RF tag 3 being capable of being updated.

2. The identification plate having multiple information media as claimed in claim 1, wherein a short range scanner is included for scanning the bar code.

3. The identification plate having multiple information media as claimed in claim 1, wherein a long range reader is included for access the RF tag through radio wave transmission.

4. The identification plate having multiple information media as claimed in claim 1, wherein the identification plate is a license plate of one of a motorcycle or car.

5. The identification plate having multiple information media as claimed in claim 4, wherein the bar code contains information of the statutory words, numbers, and symbols.

6. The identification plate having multiple information media as claimed in claim 4, wherein the RF tag contains information of vehicle registration, inspection record, tax record, periodic inspection record, and payment.

7. The identification plate having multiple information media as claimed in claim 1, wherein an image identification system is included to identify the statutory words, numbers, and symbols on the identification plate for matching the information of the identification plate so as to identify the owner of the identification plate.
